(19) United States
(12) Patent Application Publication
(10) Pub. No.: US 2025/0190379 A1
(43) Pub. Date: Jun. 12, 2025

(54) VARIABLE BURST LENGTH FOR A MEMORY DEVICE

(71) Applicant: Advanced Micro Devices, Inc., Santa Clara, CA (US)

(72) Inventors: Aaron John NYGREN, Boise, ID (US); Kevin M. LEPAK, Austin, TX (US)

(21) Appl. No.: 18/970,349

(22) Filed: Dec. 5, 2024

Related U.S. Application Data
(60) Provisional application No. 63/608,062, filed on Dec. 8, 2023.

(51) Int. Cl. G06F 13/16; G06F 13/28

(52) U.S. Cl. CPC G06F 13/1668; G06F 13/28

(57) ABSTRACT

A memory device selects a burst length to complete memory transactions. The memory device receives a first memory transaction and a second memory transaction. The memory device completes the first memory transaction using the first burst length. First data and metadata associated with the first memory transaction are transmitted to complete the first memory transaction. The memory device further completes the second memory transaction using a second burst length. A number of bursts in the first burst length is greater than a number of burst the second burst length.

### CROSS REFERENCE TO RELATED APPLICATIONS

This application claims the benefit of U.S. provisional patent application Ser. No. 63/608,062, filed Dec. 8, 2023, which is hereby incorporated herein by reference.

### TECHNICAL FIELD

Examples of the present disclosure generally relate to using a variable burst length for a memory device to support different instances of data and memory transactions.

### BACKGROUND

Memory systems include memory devices and host devices. Data is transmitted between the memory devices and the host devices via memory transactions. The memory transactions include read memory commands and write memory commands. Read memory commands are issued by a host device to read data from a memory device. A read memory command is received at a memory device and data is transmitted from the memory device to the host device based on the read memory command. Data is read from an address, or addresses, of the memory device as defined by the target address of the read memory command. Write memory commands are issued by a host device to write data to a memory device. A write memory command is received at a memory device and data is written to the memory device based on the write memory command. Data is written to an address, or addresses, of the memory device as defined by the target address of the write memory command.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1A is a block diagram of a computer system.

FIG. 1B is a block diagram of a memory system.

FIG. 2 is a block diagram of a burst length of a memory transaction.

FIG. 3 is a block diagram of burst lengths of memory transactions.

FIG. 4 illustrates a flowchart of a method for completing memory transaction using dynamic burst lengths.

FIG. 5 illustrates a table of bursts of a memory device.

### DETAILED DESCRIPTION

A memory system includes a memory device coupled with a host device. Data is transmitted between the memory device and the host device via memory transactions (or data transactions). The memory transactions include read transactions and write transactions. In a read transaction, data is read from the memory device by the host device based on a read command issued by the host device. In a write transaction, data is written to the memory device by the host device based on a write command issued by the host device. A memory transaction has a burst length of N bursts. N is 2, 4, 8, 16, 32, or more. The bursts occur at a data rate. The data rate is one bit per clock cycle or two bits per clock cycle, among others. In one example, for a burst length of 32 and a data rate of 2, at least 64 bits of data can be transmitted during a memory transaction.

In one example, a memory system uses metadata for some memory transactions, but not all of the memory transactions. Metadata may be used for memory tagging and security functions, among others. The metadata is transmitted in addition to the data associated with the memory transaction. Accordingly, an extended burst length or an extended burst width is used to accommodate transmission of the metadata. Extending the burst width provides a higher performance than extending the burst length. However, extending the burst width comes at the cost of an increased overhead for circuit area, pins, and/or printed circuit board (PCB) resources, increasing the manufacturing cost of such memory systems. In one example, to support an extended burst width, multiple lines are used to communicate the data of corresponding memory transmissions. However, using multiple lines increases the power and physical resources, increasing the cost of the corresponding memory device. An extended burst length provides a lower performance and affects all memory transactions. As all memory transactions are affected, the response time of a memory device is adversely affected as additional time is allocated to transmitting metadata, reducing the amount of memory transactions that can be transmitted in a specific period.

The memory system described herein dynamically adjusts the bursts length of memory transactions. Accordingly, the burst lengths of memory transactions that are associated with metadata are extended, while the bursts lengths of transactions that are not associated with metadata are not extended. Memory systems employing dynamically adjusted burst lengths are able to support the communication of metadata without increasing the length of memory transactions that are not associated with metadata, improving the performance of the memory systems as compared to memory systems that apply an extended burst length to all memory transactions. Further, the memory systems described herein have lower manufacturing costs as compared to memory systems that employ an extended burst width, as the burst width is not increased.

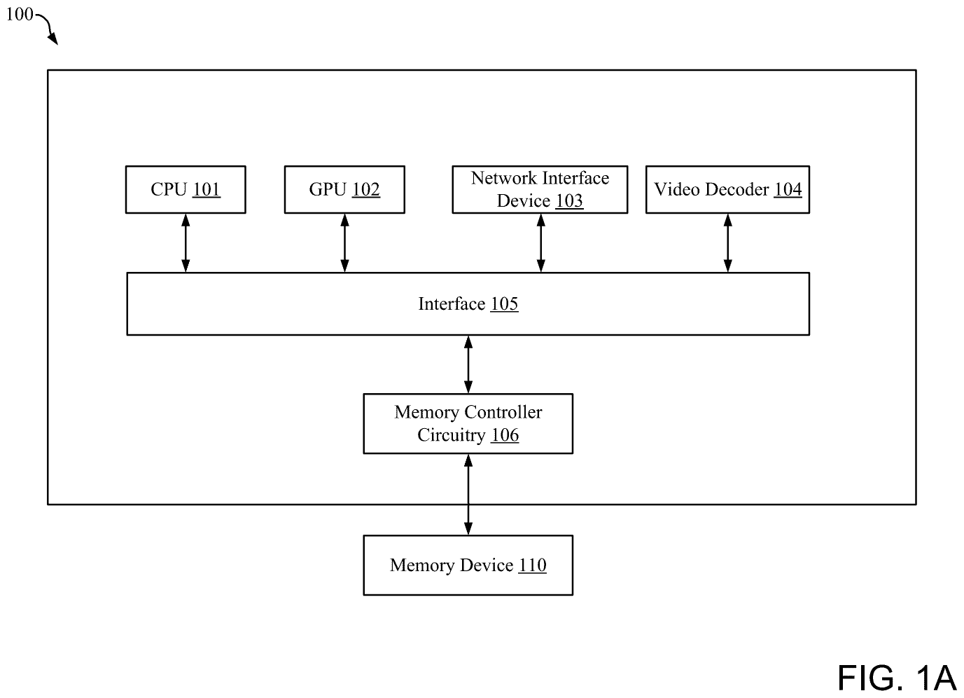

FIG. 1A illustrates a computer system 100. The computer system 100 includes one or more chips. The computer system 100 includes a central processing unit (CPU) 101, graphics processing unit (GPU) 102, network interface device 103, video decoder 104, interface 105, memory controller 106, and memory device 110. However, the computer system 100 is just one example of a computer system 100. In other examples, the computer system 100 may include fewer components than what is shown in FIG. 1A. For example, the computer system 100 may not include the GPU 102, the network interface device 103, and/or the video decoder 104. In one or more examples, the computer system 100 may include additional devices than the ones shown in FIG. 1A. Thus, FIG. 1A is just one example of components that can be included in a computer system 100.

The CPU 101 can represent any number of processors where each processor can include any number of cores. For example, the CPU 101 can include processors arranged in array, or the CPU 101 can include an array of cores. In one embodiment, the CPU 101 is an x86 processor that uses a corresponding complex instruction set. However, in other embodiments, the CPU 101 may be other types of CPUs such as an Advanced Reduced Set Instruction Computer (RSIC) Machine (ARM) processor.

The GPU 102 is an internal GPU 102 that performs accelerated computer graphics and image processing. The GPU 102 can include any number of different processing elements. In one embodiment, the GPU 102 can perform non-graphical tasks such as training an AI model or cryptocurrency mining.

The network interface device 103 allows for the computer system 100 to communicate over a network. The network may be a wired and/or wireless network.

The video decoder 104 can be used for decoding and encoding videos.

The memory controller 106 controls the memory device 110. The memory device 110 is described in greater detail in the following. The memory device 110 may be included within a common chip with the CPU 101, the GPU 102, the network interface device 103, the video decoder 104, the interface 105, and/or the memory controller circuitry 106. In one or more examples, two or more of the CPU 101, the GPU 102, the network interface device 103, the video decoder 104, the interface 105, and the memory controller circuitry 106 are included in a common chip.

The CPU 101, the GPU 102, the network interface device 103, the video decoder 104, and the memory controller 106 are communicatively coupled using an interface 105. Put differently, the interface 105 permits the different types of circuitry in the computer system 100 to communicate with each other. For example, the CPU 101 can use the interface 105 to communicate with the memory controller 106, and the memory device 110.

In one example, the computer system 100 is part of a distributed computer system. In such an example, the computer system 100 is a server computer system. In such an example, the distributed computer system includes multiple computer systems that are configured similar to the computer system 100. In one or more examples, each of the computer systems are connected via a network (wireless or wired connections), and each of the computer systems include network interconnect circuitry that is used communicate with each other.

FIG. 1B illustrates a memory system 120. The memory system 120 includes the memory device 110 and the host device 130. The memory system 120 is an integrated circuit (IC) device. The memory system 120 includes one or more IC chips. For example, the memory device 110 is part of a first one or more IC chips and the host device 130 is part of a second one or more IC chips. In one example, the memory system 120 is a system-on-chip (SoC). In such an example, the memory device 110 and the host device 130 are at least partially disposed on the same IC chip.

The host device 130 includes memory controller circuitry 106 and a processing device 132. With reference to FIG. 1A, the host device 130 may correspond to the CPU 101, the GPU 102, the network interface device 103, the video decoder 104, the interface 105, and/or the memory controller 106. The processing device 132 is the CPU 101 or a GPU 102, among others. In one or more examples, the processing device 132 is representative of multiple processing devices.

The memory controller circuitry 106 communicates signal(s) 140 (e.g., command or control, signals and data signals) to the memory device 110. The processing device 132 provides data signals to the memory controller circuitry 106. The memory controller circuitry 106 generates command signals associated with the data signals, and drives the command signals to the memory device 110 via signals 140.

The memory device 110 is dynamic random access memory (DRAM). In one example, the memory device is a double data rate (DDR) memory device. In one example, the memory device is a graphics DDR (GDDR) memory device. In other examples, the memory device 110 is a high bandwidth memory (HBM) device. A HBM device includes vertically (and/or horizontally) stacked memory device chips. In other examples, the memory device 110 may be other types of memories.

The memory device 110 includes core and driver circuitry 112. The core and driver circuitry 112 includes memory cells (e.g., bitcells), bit lines, wordlines, sense amplifier circuitry, write data circuitry, row decoder circuitry, and/or column decoder circuitry, among others. The bit lines and wordlines are connected to the memory cells and are used to select the memory cells to be read from or updated based on read and write commands issued by the memory controller circuitry 106. The sense amplifier circuitry receives data signals from the memory cells via the bit lines to facilitate a read command. The write data circuitry drives data signals onto the memory cells via the bit lines to facilitate a write command. The row decoder circuitry is coupled to the wordlines and activates one or more wordlines based on a target memory cell of a read or write command. The column decoder circuitry is coupled to the bit lines and activates one or more bit lines based on a target memory cell of a read or write command.

In one example, the core and driver circuitry 112 performs memory functions using the clock signal 114. For example, the core and driver circuitry 112 performs one or more memory functions based on the rising and/or falling edges of the clock signal 114 (e.g., bursts of the clock signal). In one example, the clock signal 114 is representative of multiple clock signals. The multiple clock signals may have different frequencies and/or one or more of the clock signals may be inverted with regard to another one of the clock signals.

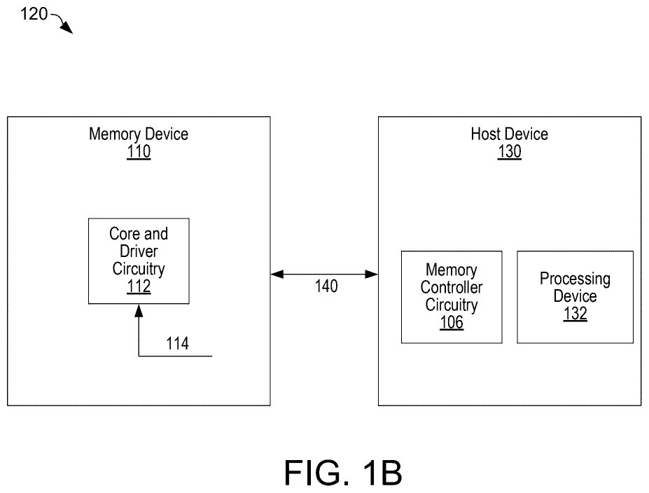

FIG. 2 illustrates a memory transaction 200 comprising a burst length of M+P. M corresponds to a number of bursts used to transmit data. P corresponds to a number of bursts used to transmit metadata (or types of data). In one or more examples, M is one or more. In one or more examples, M is 2, 4, 8, 16, or 32 or more. In one or more examples, P is 1, or more. In one example, P is 2, 4, or more. In one or more examples, P is less than M. In one specific example, M is 32 and P is 2, and the total burst length of the memory transaction 200 is 34. In other examples, the total burst length of the memory transaction 200 is more or less than 34. A memory transaction may also be referred to as a data transaction. In one or more examples, the memory transaction is a read transaction or a write transaction.

The burst length corresponds to the number of cycles of a clock signal 114 that is used to drive the core and driver circuitry 112 of the memory device (110 of FIG. 1B. The clock signal is a clock signal of the memory device 110 or a clock signal transmitted from the host device 130 to the memory device 110.

The memory transaction 200 includes bursts 210 used to transmit data and bursts 220 used to transmit metadata. Accordingly, the memory transaction includes bursts 0-P. In one example, each burst of the memory transaction corresponds to a cycle of the clock signal. In one or more example, each burst of the memory transaction corresponds to a rising edge of the clock signal or a falling edge of the clock signal.

The bursts 210 include bursts 0-M. Each of the bursts 0-M corresponds to a bit of data that can be transmitted. The bursts 220 include bursts M+1-M+P. The bursts 220 follow (e.g., are subsequent to) the bursts 210. Each of the bursts M+1-M+P correspond to a bit of metadata that can be transmitted. In one or more examples, bursts 0-M correspond to bit positions used to transmit data and the bursts M+1-M+P are bit positions used to transmit metadata. The memory transaction 200 includes bursts M-P and corresponding bit positions.

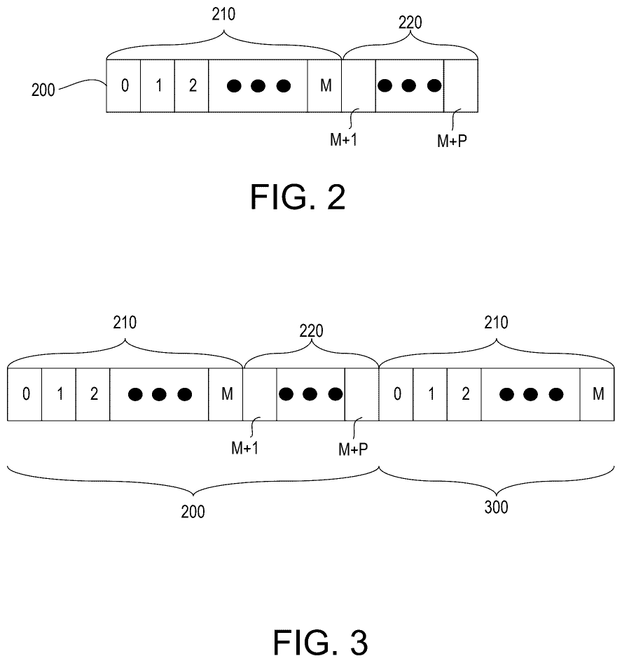

FIG. 3 illustrates memory transactions 200 and 300. The memory transaction 300 occurs subsequent to the memory transaction 200. In other examples, the memory transaction 300 occurs before the memory transaction 200. As is described above, the memory transaction 200 includes bursts 0-P, of which bursts 0-M are used to transmit data and the bursts M+1-M+P are used to transmit metadata. The memory transaction 300 comprises a burst length having M bursts. As the memory transaction 200 includes bursts 0-M+P, and the memory transaction includes bursts 0-M, the memory transaction 200 has more bursts than the memory transaction 300. In one example, a further memory transaction includes an extended burst length and a larger number of bursts than the memory transaction 200 and the memory transaction 300.

In one example, a memory transaction of 32 bits (e.g., 32 bursts) is associated with 32 or 64 bits per 512 bit cacheline in a memory.

In one example, two or more memory transactions are completed in a row using extended burst lengths (each of the memory transaction has an extended burst length). The burst lengths may have the same length or differ in length. In another example, two or more memory transactions are completed in row not using extended burst lengths (e.g., one memory transaction is completed using an extend burst length and another, or subsequent, memory transaction is completed not using an extended burst length). In one example, a least one memory transaction using an extended burst length occurs between two memory transactions not using an extended burst length. In one or more examples, a least one memory transaction not using an extended burst length occurs between two memory transactions using extended burst length(s).

In one example, the memory device 110 of FIG. 1B switches from using a burst length of M+P (e.g., an extended burst length) as shown by the memory transaction 200 to using a burst length of M as shown by the memory transaction 300. The memory device 110 may dynamically switch between different burst lengths based on whether or not metadata is associated with a memory transaction. Further, the memory device 110 may dynamically switch between different burst lengths based on an amount (e.g., number of bits) of metadata associated with a memory transaction. In one or more examples, the memory device 110 dynamically switches between different burst lengths based on the address space associated with a memory transaction. For example, an address space of the memory device 110 may be associated with an extended burst length (e.g., associated with metadata or another feature). When a memory transaction targets an address space associated within an extended burst length, an extended burst length is used to communicate data between the memory device 110 and the host device 130. In one or more examples, a flag (e.g., command flag) or another indication is associated with an address space, and provides an indication that an address space is associated or is not associated with an extended burst length. When a memory transaction having a target address for which a corresponding flag (or other indication) indicates the target address is associated with an extended burst length is executed, the corresponding data is communicated using an extended burst length. In one or more examples, a memory transaction is executed such that data is communicated using an extended burst length based on the set of address bits associated with the target address. In one or more examples, a register setting within the memory device 110 determines whether a memory transaction is executed such that data is communicated using an extended burst length. For example, the register setting may be set by a command signal (e.g., control signal) set by the host device 130, the target address of a memory transaction, or setting or operating parameter of the memory device 110.

In one example, a small percentage of memory transactions include metadata. Accordingly, the majority of memory transactions do not use extended burst lengths. In one specific example, 10% of the memory transactions include metadata. In such an example, 90% of the memory transactions do not use extended bit lengths.

With reference to FIG. 1B, in one example, the host device 130 provides the memory device 110 an indication that a memory transaction is associated with extended burst length (and metadata). The indication may be provided via a command signal communicated from the host device 130 to the memory device 110. The indication may also include the number of bursts within the extended burst length. In one example, a command flag or register setting is used to indicate that a memory transaction uses an extended burst length. Further, a command flag or register may be used to indicate the length of the extended burst length. A command signal may include one or more flags (or one or more register values) for one or more burst length extension lengths (e.g., the amount of burst in a burst length). In one example, a mode register may contain one or more settings to determine the length of a burst length extension. The host device 130 includes the mode register and outputs the command signals indicating the length of the burst length extension based on the value (or values) in the burst length extension. In one or more examples, there is an allocated address space within the memory device 110 that uses the extended burst length.

As compared to a memory system that employs an extended burst length for every memory transaction, dynamically switching between different burst lengths decreases the number of bursts for each memory transaction, allowing more memory transactions to be transmitted for a given amount of time and increasing the performance for the corresponding memory system. As shown in FIG. 3 and for an M of 32 and a P of 2, the total number of bursts within the memory transactions 200 and 300 is 66. However, for two memory transactions having an extended burst length of 34 to support the transmission of metadata, the total number of bursts is 68. Accordingly, over multiple memory transactions, where some of the memory transactions do not include associated metadata, a reduced number of bursts are used to transmit the same amount of data when using the dynamic burst length as described herein.

Metadata has various uses in a memory device. In one or more examples, the metadata is used in database server systems. In a database server system, the metadata is used for coherence directories. One or more error correction codes (ECC) bits are used to store the coherence metadata.

In a JEDEC (Joint Electron Device Engineering Council) specification (and other design specifications), metadata is used for ECC codes. The length (e.g., number) of the ECC codes may be based on the strength of the ECC code.

In one example, the metadata is used for security functions. For example, cyclic redundancy check (CRC) data may be communicated to and from a memory device via the metadata.

In one example, the metadata is used for ciphertext hiding. In one example, hyper-visor spaced is used to store the metadata associated with the ciphertext hiding. Ciphertext hiding is a per-cacheline attribute. A cacheline corresponds to a block or line of memory within the memory device 110. Ciphertext hiding may be used in both secure and insecure guests and can be run on the same computer system. In ciphertext hiding, burst lengths associated with secure guests may be extended dynamically.

In one example, memory caching solutions can use metadata to store various attributes of the caching. In one or more examples, the metadata is used for eviction policies, hashing, dependency information, and/or priority information, among others. Memory caching corresponds to temporarily storing data in a memory device that is local to a processing device. The memory device used for memory cache may be smaller than a main (or external) memory device. In one or more examples, not all memory devices enable caching.

In one example, the metadata is used for memory tagging. Memory tagging is a pointer and memory allocation protection feature.

In one example, the metadata is used within tiered memory caching. In tiered memory caching, data is stored across multiple cache layers. The cache layers may have different performance and/or size parameters. A portion of the memory in the memory device 110 is used for a cache of a multi-tier memory device, and access to the portion of the memory used for cache uses burst length extensions. In one example where tiered memory caching is used, a compute express link (CXL) may be used. A CXL is a high-speed interconnect that may be used to communicate data to and from the memory device (e.g., the memory device 110 of FIG. 1B).

In one example, the metadata is used with coherence scaling (e.g., directories in the memory device 110 of FIG. 1B). In one example, information related to the state (e.g., open, dirty, or copied, among others) of lines (e.g., addresses) within the memory device 110 may be stored as metadata.

In one example, using metadata in non-ECC based memory devices allows for one or more features related to an ECC memory device to be completed in a processing device of a host device (e.g., the processing device 132 of FIG. 1B). Accordingly, ECC functions can be added to lower cost system products. For example, the use of metadata allows for ECC processes to be distributed on the devices used to communicate and receive data (e.g., the core and driver circuitry 112, the memory controller circuitry 106 and/or the processing device 132). In one example, ECC data is stored as metadata and associated with addresses within the memory device 110. The ECC data is transmitted with the data between the memory device 110 and the host device 130. The ECC data is used by the memory device 110 and/or the host device 130 to perform ECC processes and validate data transmitted between the memory device 110 and the host device 130.

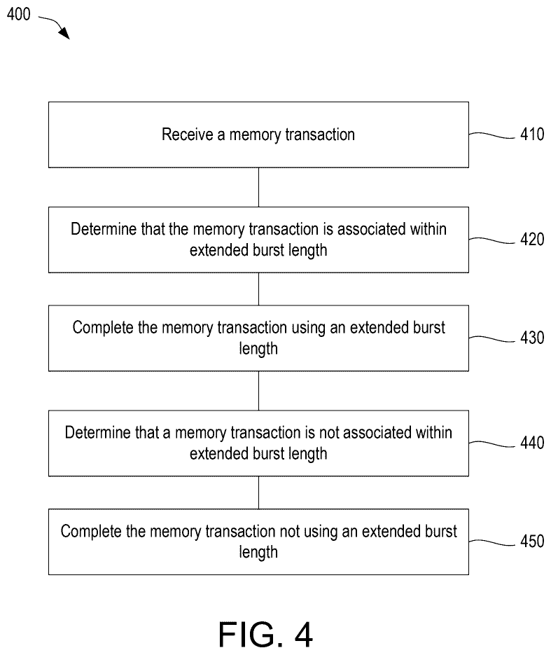

FIG. 4 illustrates a flowchart of a method 400 for servicing memory transactions using a dynamic burst length. In one example, the method 400 is performed by the memory system 120 of FIG. 1B. In completing the method 400, the memory device 110 dynamically selects for which memory transactions extended burst lengths are used and for which memory transaction extended bursts lengths are not used. The process described in the method 400 is applied continuously to determine whether or not an extended burst length is used to complete a memory transaction.

At 410 of the method 400, a memory transaction is received. For example, the memory device 110 receives a memory transaction from the memory controller circuitry 106 of the host device 130 via the signal(s) 140. The processing device 132 of the host device 130 outputs one or more signals (e.g., data signals and/or control signals) to the memory controller circuitry 106. The memory controller circuitry 106 generates a memory transaction from the one or more signals. The memory controller circuitry 106 outputs the memory transaction via the signal(s) 140. In one example, the memory controller circuitry 106 determines that the one or more signals are associated with a data read request and a corresponding target address. The memory controller circuitry 106 generates a read transaction based on the one or more signals. The read transaction includes a read command and a target address. The read transaction is communicated by one or more signals 140 from the host device 130 to the memory device 110. In another example, the memory controller circuitry 106 determines that the one or more signals are associated with a data write request and a corresponding target address. The memory controller circuitry 106 generates a write transaction based on the one or more signals. The write transaction includes a write command and a target address. The write transaction is communicated by one or more signals 140 from the host device 130 to the memory device 110.

At 420 of the method 400, the memory transaction is determined to be associated with an extended burst length. For example, the memory device 110 determines that the memory transaction is associated with an extended burst length. The memory device 110 determines whether or not a memory transaction is associated with a burst length from one or more command flags and/or one or more register values (e.g., settings) that correspond to the memory transaction. In one example, the memory controller circuitry 106 determines that a target address is associated with an extended burst length and communicates a command flag or register value to the memory device 110 via a command signal (e.g., the signal(s) 140) indicating that the corresponding memory transaction is associated with an extended burst length. For example, the memory device 110 determines that a flag (or other indication) is associated with the target address of the memory transaction, indicating that the target address is associated with an extended burst length. In one example, the flag may be stored within the memory device 110 and associated with the target address. In another example, the flag (or other indication) is communicated from the host device 130, e.g., the memory controller circuitry 106, as the signal(s) 140 with the memory transaction.

In one or more examples, the memory device 110 determines that a memory transaction corresponds to an extended burst length based on a received control signal (e.g., the signal(s) 140). In one example, memory device 110 determines whether or not a register value associated with the target address of the memory transaction indicates that the target address is associated with an extended burst length. Addresses associated with an extended burst length may be determined by the memory device 110 based on the metadata or another feature of the addresses. For example, the memory device 110 determines which addresses are associated with an extended burst length based on whether or not an address is associated with metadata (or another feature). In one example, the memory device 110 includes stored metadata. The memory device 110 analyzes the stored metadata to identify which addresses are associated with the metadata (e.g., ciphertext hiding, tiered memory caching, coherence scaling, ECC codes, other security functions, or memory tagging, among others). The memory device 110 sets a flag or register value for each address that is determined to be associated with metadata (e.g., ciphertext hiding, tiered memory caching, coherence scaling, ECC codes, other security functions, or memory tagging, among others), indicating that the addresses are associated with an extended burst length.

In one example, the memory device 110 determines the length of the extended burst length based on the type and/or amount of metadata associated with the address. The length of the extended burst length is associated with address via a flag or register value, or another indication. In one example, the memory controller circuitry 106 determines that metadata of a target memory address is associated with ciphertext hiding, tiered memory caching, coherence scaling, ECC codes, other security functions, or memory tagging, among others, and sets a command flag or register value indicating that the corresponding memory transaction corresponds to an extended burst length. In one or more examples, a memory transaction is executed such that data is communicated using an extended burst length based on the set of address bits associated with the target address. The memory device 110 determines that the set of address bits of the target address are associated with an extended burst length, and communicates data using an extended burst length. In one or more examples, the memory device 110 determines that a register setting (mode) within the memory device 110 indicates that an extended burst length is to be used to execute a memory transaction. The register setting may be set by a command signal (e.g., control signal) set by the host device 130, the target address of a memory transaction, or setting or operating parameter of the memory device 110.

In one example, a length of the extended burst length is determined based on the type of metadata. The length of the extended burst length may be included within the command flag or the register value. The command flag or register value is communicated via a command (or control) signal as part of the memory transaction communicated (e.g., output or provided) to the memory device 110.

In one or more example, determining the length of the extended burst length includes determining a number of bursts within the burst length from the target address and/or type of metadata. In one example, the number of bursts is determined based on the function (e.g., ciphertext hiding, tiered memory caching, coherence scaling, ECC codes, other security functions, or memory tagging, among others) associated with the metadata of a target address of a memory transaction.

At 430, memory transaction is completed using an extended burst length. For example, the memory device 110 transmits data using a first one or more bursts and metadata using a second one or more bursts to perform a read transaction. For a write transaction, the memory controller circuitry 106 outputs data to the memory device 110 using a first one or more bursts, and metadata using a second one or more bursts to, and the memory device 110 writes the data and metadata to a corresponding address.

At 440 of the method 400, a memory transaction is determined to not be associated with an extended burst length. For example, the memory device 110 determines that a memory transaction received via the signal(s) 140 is not associated with an extended burst length as is described above with regard to 420 of the method 400. In one example, the memory device 110 determines that a memory transaction is not associated with a burst length from one or more command flags and/or one or more register values (e.g., settings) that correspond to the memory transaction. The command flags or register values may be communicated by a control signal (e.g., the signal(s) 140) from the memory controller circuitry 106 or stored locally within the memory device 110.

At 440, a memory transaction is completed not using an extended burst length. For example for a read command, the memory device 110 transmits data to the host device 130 (e.g., the memory controller circuitry 106) using a first one or more bursts. Additional bursts (e.g., a second one or more bursts) are not used to transmit metadata. For example, for a read transaction that is not associated metadata, an extended burst length is not used to transmit the corresponding data. Accordingly, such a read transaction can be transmitted using less bursts than a read transaction that is associated with metadata. For a write transaction, the memory controller circuitry 106 outputs data to the memory device 110 using a first one or more bursts and does not transmit metadata using a second one or more bursts. Such a write transaction may is not associated with metadata, accordingly bursts are not used to transmit the metadata. Accordingly, such a write transaction can be transmitted using less bursts than a write transaction that is associated with metadata.

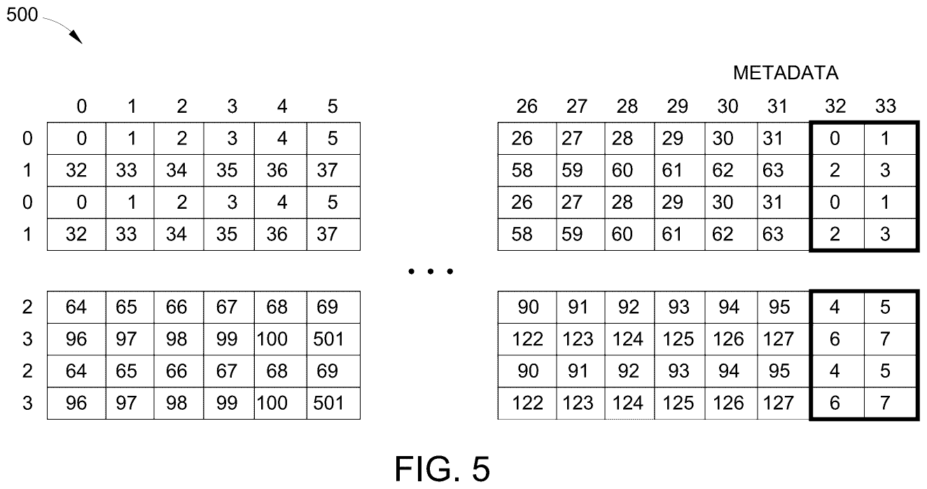

The table 500 of FIG. 5 illustrates an example of how the metadata is distributed in memory lines. In one example, a memory line maybe referred to a cacheline. A memory line (or cacheline) is a fixed-size unit within the memory device 110. The X-direction is time represented by the burst position. In one example, standard burst would end at position 31 (e.g., positions 0-31). The extended burst length includes positions 32 and 33. In one example, metadata has a size of 1 bit, 2 bits, or more. In examples where extended burst lengths are used with each memory transaction, a 1 bit metadata size has a 1.56% capacity loss in the corresponding memory device, a 2 bit metadata size has a 3.125% capacity loss in the corresponding memory device, and a 4 bit metadata size has a 6.25% capacity loss in the corresponding memory device. However, by dynamically (e.g., selectively) applying extended burst lengths to memory transactions, the amount of space allocated to store the metadata is reduced in each of the above examples as not all memory addresses are associated with metadata, and storage space is allocated to memory addresses associated with metadata. Accordingly, in the memory system described herein there is a reduced amount of memory loss associated with the storage of metadata.

As is described above, the use of an extended burst length is dynamically determined for each memory transaction. In one example, the number of bursts within a burst length is different and selectable for two or more extended burst lengths or the same for two or more extended burst lengths. The memory controller circuitry 106 of the host device 130 and/or the memory device 110 determines for which memory transaction an extended burst length is used. The determination is based on features assigned to a target address of the memory transaction. Accordingly, extended burst lengths are used for a fraction of the memory transactions, increasing the performance of the corresponding memory system.

In one or more examples, a method includes completing a first memory transaction using a first burst length. The first data is associated with the first memory transaction and metadata associated with the first memory transaction are transmitted to complete the first memory transaction. The method further includes completing a second memory transaction using a second burst length. A number of bursts in the first burst length is greater than a number of bursts in the second burst length.

In one or more examples, the method further includes receiving, at a memory device, the first memory transaction and the second memory transaction, and determining, at the memory device, that the first memory transaction is associated with the first burst length. In one or more examples, the method further includes receiving a command signal associated with the first memory transaction. Determining that the first memory transaction is associated with the first burst length is based on the command signal. In one or more examples, the command signal is output from memory controller circuitry of a host device, and the memory controller circuitry is configured to generate the command signal based on a determination that a target address of the first memory transaction is associated with the first burst length.

In one or more examples, the method includes determining, by a memory device, that the first memory transaction is associated with the first burst length based on a target address of the first memory transaction.

In one or more examples, the first memory transaction is a read transaction, and completing the first memory transaction includes outputting the first data with a first at least one burst and the metadata with a second at least one burst, or the first memory transaction is a write transaction, and completing the first memory transaction includes receiving the first data with a first at least one burst and the metadata with a second at least one burst.

In one or more examples, the method further includes determining a number of bursts of the first burst length.

In one or more examples, the method further includes completing a third memory transaction using a third burst length. A number of bursts of the third burst length is greater than or equal to the number of bursts of the first burst length.

In one or more examples, a memory device completes a first memory transaction using a first burst length. First data associated with the first memory transaction and metadata associated with the first memory transaction are transmitted to complete the first memory transaction. Further, the memory device completes a second memory transaction using a second burst length. A number of bursts in the first burst length is greater than a number of bursts in the second burst length.

In one or more examples, the memory device further receive the first memory transaction and the second memory transaction, and determines that the first memory transaction is associated with the first burst length. In one or more examples, the memory device further receives a command signal associated with the first memory transaction. Determining that the first memory transaction is associated with the first burst length is based on the command signal. In one or more examples, the command signal is output from memory controller circuitry of a host device connected to the memory device, and the memory controller circuitry generates the command signal based on a determination that a target address of the first memory transaction is associated with the first burst length.

In one or more examples, the memory device further determines that the first memory transaction is associated with the first burst length based on a target address of the first memory transaction.

In one or more examples, the first memory transaction is a read transaction, and completing the first memory transaction includes outputting the first data with a first at least one burst and the metadata with a second at least one burst, or the first memory transaction is a write transaction, and completing the first memory transaction includes receiving the first data with a first at least one burst and the metadata with a second at least one burst.

In one or more examples, the memory device further determines a number of bursts of the first burst length.

In one or more examples, the memory device further completes a third memory transaction using a third burst length. A number of bursts of the third burst length is greater than or equal to the number of bursts of the first burst length.

In one or more examples, a memory system includes a host device including a memory controller circuitry that outputs a first memory transaction and a second memory transaction. The memory system further includes a memory device that receives the first memory transaction and the second memory transaction. Further, the memory device completes the first memory transaction using a first burst length. First data associated with the first memory transaction and metadata associated with the first memory transaction are transmitted to complete the first memory transaction. The memory device further completes the second memory transaction using a second burst length. A number of bursts in the first burst length is greater than a number of burst in the second burst length.

In one or more example, the memory device is further receives a command signal associated with the first memory transaction, and wherein determining that the first memory transaction is associated with the first burst length is based on the command signal. In one or more examples, the command signal is output from the memory controller circuitry to the memory device, and the memory controller circuitry is configured to generate the command signal based on a determination that a target address of the first memory transaction is associated with the first burst length. In one or more examples, the memory device is further determines that the first memory transaction is associated with the first burst length based on a target address of the first memory transaction.

While the foregoing is directed to specific examples, other and further examples may be devised without departing from the basic scope thereof, and the scope thereof is determined by the claims that follow.

What is claimed is:

1. A method comprising:
completing a first memory transaction using a first burst length, wherein first data associated with the first memory transaction and metadata associated with the first memory transaction are transmitted to complete the first memory transaction; and
completing a second memory transaction using a second burst length, wherein a number of bursts in the first burst length is greater than a number of bursts in the second burst length.

2. The method of claim 1 further comprising:
receiving, at a memory device, the first memory transaction and the second memory transaction, wherein completing the first memory transaction using the first burst length is based on receiving the first memory transaction at the memory device.

3. The method of claim 2 further comprising:
receiving a command signal associated with the first memory transaction, and wherein the first memory transaction is completed using the first burst length is based on the command signal.

4. The method of claim 3, wherein the command signal is output from memory controller circuitry of a host device, and the memory controller circuitry is configured to generate the command signal based on a target address of the first memory transaction being associated with the first burst length.

5. The method of claim 1 further comprising determining, by a memory device, that the first memory transaction is associated with the first burst length based on a target address of the first memory transaction.

6. The method of claim 1, wherein
the first memory transaction is a read transaction, and completing the first memory transaction includes outputting the first data with first bursts and the metadata with a second burst.

7. The method of claim 1, wherein the first memory transaction is a write transaction, and completing the first memory transaction includes receiving the first data with first bursts and the metadata with a second burst.

8. The method of claim 1 further comprising completing a third memory transaction using a third burst length, wherein a number of bursts of the third burst length is greater than or equal to the number of bursts of the first burst length.

9. A memory device configured to:
complete a first memory transaction using a first burst length, wherein first data associated with the first memory transaction and metadata associated with the first memory transaction are transmitted to complete the first memory transaction; and
complete a second memory transaction using a second burst length, wherein a number of bursts in the first burst length is greater than a number of bursts in the second burst length.

10. The memory device of claim 9 further configured to:
receive the first memory transaction and the second memory transaction, wherein completing the first memory transaction using the first burst length is based on receiving the first memory transaction.

11. The memory device of claim 10 further configured to:
receive a command signal associated with the first memory transaction, and wherein the first memory transaction is completed using the first burst length is based on the command signal.

12. The memory device of claim 11, wherein the command signal is output from memory controller circuitry of a host device connected to the memory device, and the memory controller circuitry is configured to generate the command signal based on t a target address of the first memory transaction being associated with the first burst length.

13. The memory device of claim 9 further configured to determine that the first memory transaction is associated with the first burst length based on a target address of the first memory transaction.

14. The memory device of claim 9, wherein one of:
the first memory transaction is a read transaction, and completing the first memory transaction includes outputting the first data with first bursts and the metadata with a second burst; or
the first memory transaction is a write transaction, and completing the first memory transaction includes receiving the first data with first bursts and the metadata with a second bursts.

15. The memory device of claim 9 further configured to complete a third memory transaction using a third burst length, wherein a number of bursts of the third burst length is greater than or equal to the number of bursts of the first burst length.

16. A memory system comprising:
a host device comprising a memory controller circuitry configured to output a first memory transaction and a second memory transaction; and
a memory device configured to:
receive the first memory transaction and the second memory transaction;
complete the first memory transaction using a first burst length, wherein first data associated with the first memory transaction and metadata associated with the first memory transaction are transmitted to complete the first memory transaction; and
complete the second memory transaction using a second burst length, wherein a number of bursts in the first burst length is greater than a number of burst in the second burst length.

17. The memory system of claim 16, wherein the memory device is further configured to:
receive a command signal associated with the first memory transaction, and wherein the first memory transaction is completed using the first burst length is based on the command signal.

18. The memory system of claim 17, wherein the command signal is output from the memory controller circuitry to the memory device, and the memory controller circuitry is configured to generate the command signal based on a target address of the first memory transaction being associated with the first burst length.

19. The memory system of claim 16, wherein the memory device is further configured to determine that the first memory transaction is associated with the first burst length based on a target address of the first memory transaction.

20. The memory system of claim 16, wherein the memory device is further configured to:
receive a third memory transaction from the memory controller circuitry; and
complete the third memory transaction using a third burst length, wherein a number of bursts of the third burst length is greater than or equal to the number of bursts of the first burst length.
